(19) United States
(12) Patent Application Publication
(10) Pub. No.: US 2019/0145479 A1
(43) Pub. Date: May 16, 2019

(54) METALLIC GLASS ELASTIC ELEMENT SYSTEM AND METHOD

(71) Applicant: GM GLOBAL TECHNOLOGY OPERATIONS LLC, Detroit, MI (US)

(72) Inventors: Jianfeng Wang, Nanjing (CN); Chengwu Duan, Songjiang District (CN)

(73) Assignee: GM GLOBAL TECHNOLOGY OPERATIONS LLC, Detroit, MI (US)

(21) Appl. No.: 15/810,770

(22) Filed: Nov. 13, 2017

(51) Int. Cl. F16F 1/32

(52) U.S. Cl. CPC F16F 1/32; F16F 2226/04; F16F 2224/0208; F16F 2232/08; F16F 2234/04

(57) ABSTRACT

Systems and methods are provided with elastic elements that have configurable characteristics of force and displacement for a variety of applications. An elastic element is configured to deflect from a base shape when a load is applied and to resume the base shape when the load is removed. The elastic element formed of a metallic glass material. The elastic element applies a force to a moveable element.

### TECHNICAL FIELD

The present disclosure generally relates to systems and methods for applying a tunable elastic force, and more particularly relates to the use of metallic glass elastic elements to apply force in a mechanical system.

### INTRODUCTION

Spring-like elements are available in a wide variety of forms. For example, coil, torsion, disc, leaf and clip springs, as well as resilient material components serve as elastic elements for uses such as force application, clamping and vibration damping. These elements may experience fatigue degradation under load or after repeated cycling, may have limited stiffness ranges, and may be difficult to form for restricted packaging spaces.

Accordingly, it is desirable to provide systems and methods that provide elastic elements with greater design flexibility. Furthermore, other desirable features and characteristics of the present invention will become apparent from the subsequent detailed description and the appended claims, taken in conjunction with the accompanying drawings and the foregoing technical field and introduction.

### SUMMARY

Systems and methods are provided with elastic elements that have configurable force versus displacement characteristics for a variety of applications. In various embodiments, an elastic element is configured to deflect from a base shape when a load is applied and to resume the base shape when the load is removed. The elastic element formed of a metallic glass material. The elastic element applies a force to a moveable element.

In other embodiments, the elastic element has a cross sectional profile that is configured to vary the force as the elastic element deflects.

In other embodiments, the elastic element has a shape that is irregular and that is determined by a space within which the elastic element is disposed.

In other embodiments, the elastic element is shaped as a disc with a center opening and with a periphery opposite the center opening at an outermost edge of the elastic element. The elastic element has a cross sectional profile with one thickness at the center opening and a different thickness at the periphery

In other embodiments, the elastic element has a cross sectional profile with a thickness that varies and that may include ribs and grooves configured to vary the force as the elastic element deflects.

In other embodiments, the elastic element is disposed within a continuously variable transmission. A sheave in the continuously variable transmission is variable in diameter, and the elastic element applies the force to the sheave.

In other embodiments, a piston with a rod engages the sheave, and the elastic element is disposed around the rod. The elastic element may be disc shaped with a center opening through which the rod extends.

In other embodiments, the elastic element has a conical shape.

In another embodiment, a method includes forming an elastic element in a base shape which deflects when a load is applied and which resumes the base shape when the load is removed. The elastic element is formed of a metallic glass material. A moveable element is positioned so that the elastic element applies a force to the moveable element.

In other embodiments, the method includes forming the elastic element with a cross sectional profile that is configured to vary the force as the elastic element deflects.

In other embodiments, the method includes forming the elastic element with a shape that is irregular and that is determined by a space within which the elastic element is disposed.

In other embodiments, the method includes shaping the elastic element as a disc with a center opening and a periphery opposite the center opening at an outermost edge of the elastic element. A cross sectional profile of the elastic element is cast with one thickness at the center opening and another second thickness at the periphery.

In other embodiments, the method includes casting the elastic element with a cross sectional profile that has a thickness that varies.

In other embodiments, the method includes casting ribs and grooves on the elastic element, configured to vary the force as the elastic element deflects.

In other embodiments, the method includes positioning the elastic element in a continuously variable transmission. The elastic element applies the force to a sheave in the continuously variable transmission that has a variable in diameter.

In other embodiments, the method includes engaging the sheave with a piston rod, and the elastic element is positioned around the rod.

In other embodiments, the method includes shaping the elastic element as a disc with an opening at its center, and extending the rod through the opening

In additional embodiments, an elastic element is formed in a disc shape and is configured to deflect from a base shape when a load is applied and to resume the base shape when the load is removed. The elastic element is cast of a metallic glass material. A rib is cast onto the elastic element and is configured to vary force as the elastic element deflects. The elastic element applies the force to a moveable element.

### BRIEF DESCRIPTION OF THE DRAWINGS

The exemplary embodiments will hereinafter be described in conjunction with the following drawing figures, wherein like numerals denote like elements, and wherein:

FIG. 1 illustrates an elastic element in cross section taken generally through the line indicated as 1-1 in FIG. 3;

FIG. 2 is a schematic illustration of a continuously variable transmission application that uses an elastic element to provide clamping assistance;

FIG. 3 is an illustration of the elastic element of FIG. 1;

FIG. 4 is an illustration of an elastic element in accordance with various embodiments;

FIG. 5 is a cross sectional illustration of an elastic element in accordance with various embodiments, showing an enlarged detail area; and

FIG. 6 is a graph of force versus displacement for various elastic elements.

### DETAILED DESCRIPTION

The following detailed description is merely exemplary in nature and is not intended to limit the application or its uses. Furthermore, there is no intention to be bound by any expressed or implied theory presented in the preceding technical field, introduction, brief summary or the following detailed description.

In one or more example implementations of the disclosed elastic element system and method, tunable stiffness is provided. Generally, the stiffness may be tailored through variations in cross sectional thickness enabled by using metallic glass to form the elastic element. High fatigue life is achievable with lifetime consistent performance as a result of near zero stress relaxation of the metallic glass material. In certain embodiments, irregular shapes of the elastic element may readily be formed such as by casting, to fit the packaging space dictated by the application.

The current description relates to elastic element systems that may be described in the context of a mechanical system application and in particular, a continuously variable transmission (CVT) system, for purposes of demonstrating an example. During operation, it may be useful to control the movement of the CVT's sheaves under controlled force and/or at variable forces. For example, to effectively vary the diameter of a sheave, one force may be preferred at a specific operating point of the CVT and another force may be preferred at a different operating point of the CVT.

The present disclosure is not limited to CVT applications or to transmissions in general, but rather, also encompasses any application where a consistently repeatable application of a force profile by an elastic element is desired. Accordingly, the teachings of the present disclosure are applicable to mechanical systems in a variety of applications, such as vehicle systems, machinery and equipment systems, and others.

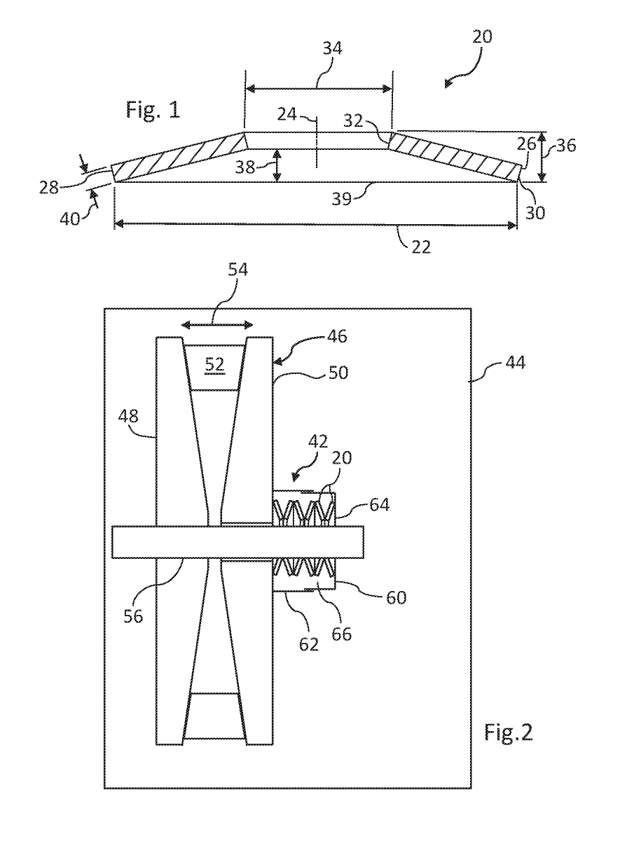

In an exemplary embodiment of the present disclosure as further described below, an elastic element is configured to deflect from a base shape when a load is applied and to resume the base shape when the load is removed. The elastic element is formed of a metallic glass material. The elastic element applies a force to a moveable element to effect a desired action. Accordingly, with reference to FIG. 1 an elastic element 20 is shown in its base shape. The elastic element 20 is formed as a spring disc, sometimes referred to as a Belleville spring, and generally has the shape of a conical section. The elastic element 20 has an external diameter 22 measured across its center 24 to its peripheral edge 26 on each side 28, 30. The elastic element 20 has an opening 32 centered on the center 24 defining an internal diameter 34. When in the base shape as shown in FIG. 1, the elastic element 20 has a free disc height 36 and a free cone height 38, each measured from the base 39 of the elastic element 20. The elastic element 20 has a thickness 40 which may be consistent, or may vary as further detailed below.

In the embodiment of FIG. 1, the elastic element 20 is formed from a metallic glass material, sometimes referred to as amorphous metal. For example, the material may be a metal with a non-crystalline structure. Metals are typically crystalline in their solid state, however, the elastic element 20 is formed of a metallic glass is a metal, which may be an alloy, that has a glass-like structure. The metallic glass material is formed in the desired shape through the use of a mold such as in casting or injection molding. As the metallic glass material cools in the mold and transitions from the liquid to solid state, no phase change occurs so the material maintains a glass-like structure. Accordingly, the material maintains a random, rather than an ordered structure and exhibits desirable properties as a result. The material may be alloyed from a wide variety of constituents including magnesium, yttrium, zirconium, beryllium, titanium, copper, nickel, zinc, niobium, aluminum, and others. The material may be formed through various processes including extremely rapid cooling, physical vapor deposition, solid-state reaction, ion irradiation, and mechanical alloying.

With reference to FIG. 2, an application for the elastic element 20 is illustrated as an elastic element system 42 of a CVT 44. As noted above, the elastic element system 42 described herein may be employed in a variety of applications. In this example, the elastic element system 42 includes the elastic element 20 shown in a state that is compressed from the base shape of FIG. 1. The CVT 44 includes a sheave set 46 with a pair of sheave halves 48, 50 engaged with a drive chain 52. The sheave halves 48, 50 are moveable relative to each other in the direction 54 to vary the effective diameter that the drive chain 52 experiences as it travels around the sheave set 46. In this example, a rod 56 extends through the sheave halves 48, 50 and controls their spacing. The rod 56 is fixed relative to the sheave half 48 and the sheave 50 is moveable relative to the rod 56. As a result, the sheave half 50 is moveable relative to the sheave half 48. In this example, a member 60 is fixed to the rod 56. Another member 62 mates with the member 60 forming a container 64 that defines a chamber 66, within which the elastic element 20 is disposed. It will be appreciated that multiple elastic elements 20 may be included in a stacked fashion as shown. When stacked, the elastic elements 20 may face in the same directions or alternating elastic elements 20 may face in opposite directions as shown. In this example, the elastic element(s) 20 applies a force to the sheave half 50 as a moveable element to force the sheave halves 48, 50 toward one another to increase the diameter of the sheave set 46. The chamber 66 may be operated with fluid pressure to move the sheave half 50 and member 62 as a piston, with assistance of the elastic element 20, or the piston may be moved through other mechanisms or by the elastic element 20 alone, or by multiple elastic elements 20.

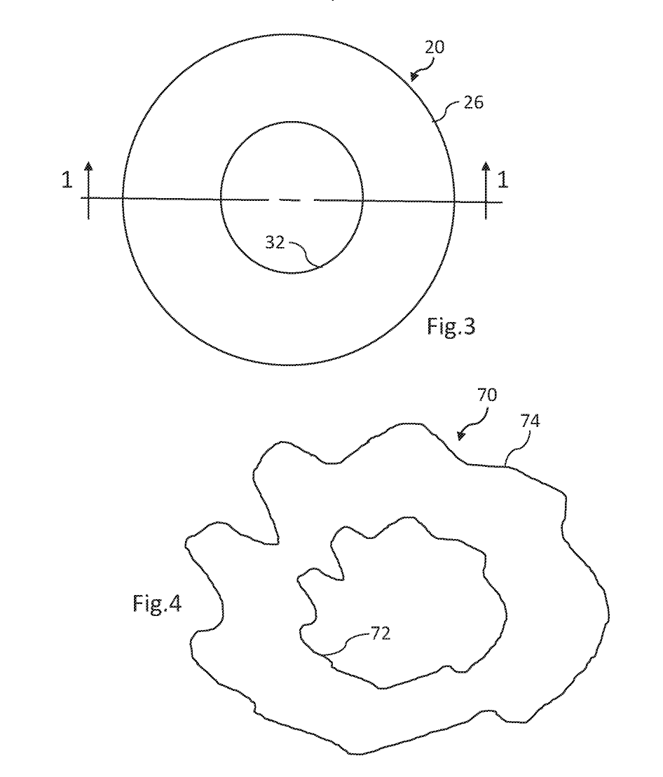

Referring to FIG. 3, in a number of embodiments the elastic element 20 has a circular disc shape with the opening 32 and the peripheral edge 26. In other examples such as shown in FIG. 4, the use of metallic glass to form the elastic element 70 enables providing irregular shapes such as that defined by the opening 72 and the peripheral edge 74. In this example, both the opening 72 and the peripheral edge 74 are irregular in shape. In other examples, only one of the opening 72 or the peripheral edge 74 is irregular. The shape is irregular meaning that it departs from a standard circular, elliptical or polygon shape and is determined by the space within which the elastic element 70 must fit. Because the elastic element is 70 formed by molding, the cavity or die within which it is molded may be formed in the needed shape.

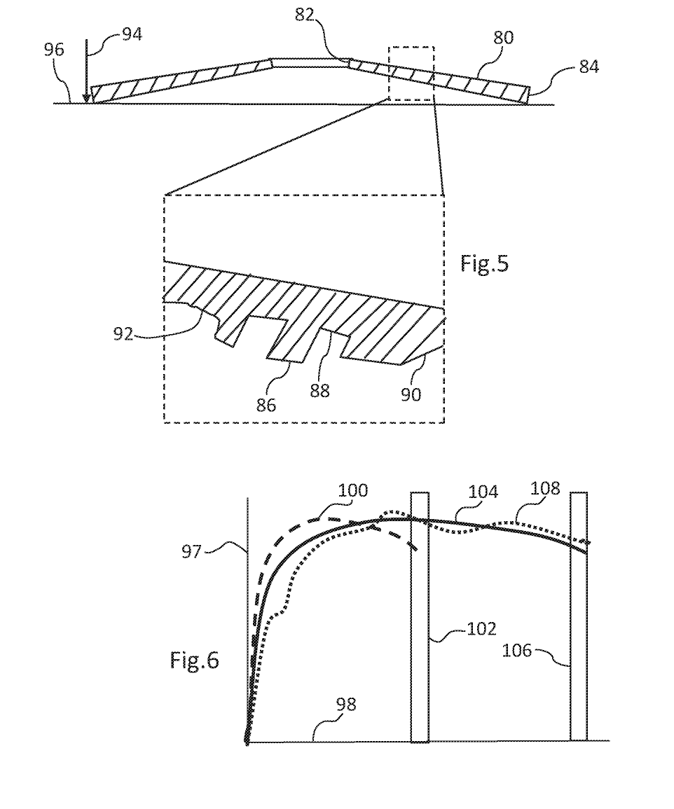

In a number of embodiments such as shown in FIG. 5, an elastic element 80, such as for use in the CVT 44, is formed from a metallic glass material. The elastic element 80 has a thickness that varies from the opening 82 to the peripheral edge 84. In this example, the thickness is greater at the peripheral edge 84 than at the opening 82. Accordingly, the cross section of the elastic element 80 has a profile that varies and is thicker at its end adjacent the opening 82 and in thinner at its end at the peripheral edge 84. In this example, the thickness also varies along the cross section with ribs 86 and grooves 88 between a pair of ribs 86. The thickness also varies as defined by sections with an angled surface 90 and an irregularly contoured surface 92. The thickness, including the ribs 86, grooves 88, angled surface 90 and irregularly contoured surface 92 result in a varying force 94 applied to the moveable element 96 as the elastic element 80 flexes through compression and decompression.

Referring to FIG. 6, a graph shows force on the vertical axis 96 versus displacement on the horizontal axis 98 represented as displacement over free cone height 38. Curve 100 shows the response of a typical stamped steel disc washer from the origin through the testing limit zone 102. Curve 104 shows the response of the elastic element 20 from the origin through the testing limit zone 106. Demonstrated is that the testing limit of the elastic element 20 is higher and the force profile is maintained at a high level over a broader range. Curve 108 shows the response of the elastic element 70 from the origin to the testing limit zone 106. Demonstrated is that the force varies as a result of the tuned stiffness from the ribs, grooves and other features of the profile.

Accordingly, an elastic element system and a method provide tunable stiffness that may be tailored through variations in cross sectional thickness enabled by using metallic glass to form the elastic element. High fatigue life is achievable with lifetime consistent performance as a result of near zero stress relaxation of the metallic glass material. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system comprising:
an elastic element configured to deflect from a base shape when a load is applied to the elastic element and to resume the base shape when the load is removed, the elastic element formed of a metallic glass material; and
a moveable element upon which the elastic element applies a force.

2. The system of claim 1 wherein the elastic element has a cross sectional profile that is configured to vary the force as the elastic element deflects.

3. The system of claim 1 wherein the elastic element has a shape that is irregular and that is determined by a space within which the elastic element is disposed.

4. The system of claim 1 wherein the elastic element is shaped as a disc with a center opening and a periphery opposite the center opening at an outermost edge of the elastic element, the elastic element having a cross sectional profile with a first thickness at the center opening and a second thickness at the periphery, wherein the first and second thicknesses are different from one another.

5. The system of claim 1 wherein the elastic element has a cross sectional profile with a thickness, wherein the thickness varies.

6. The system of claim 5 wherein the thickness includes ribs and grooves between the ribs, which are configured to vary the force as the elastic element deflects.

7. The system of claim 1 comprising:
a continuously variable transmission within which the elastic element is disposed;
a sheave in the continuously variable transmission that is variable in diameter, wherein the elastic element applies the force to the sheave.

8. The system of claim 7 comprising a piston with a rod engaging the sheave, wherein the elastic element is disposed around the rod.

9. The system of claim 8 wherein the elastic element is disc shaped with a center opening through which the rod extends.

10. The system of claim 9 wherein the elastic element has a conical shape.

11. A method of comprising:
forming an elastic element in a base shape which deflects when a load is applied to the elastic element and which resumes the base shape when the load is removed, the elastic element formed of a metallic glass material; and
positioning a moveable element so that the elastic element applies a force to the moveable element.

12. The method of claim 11 comprising forming the elastic element with a cross sectional profile that is configured to vary the force as the elastic element deflects.

13. The method of claim 11 comprising forming the elastic element with a shape that is irregular and that is determined by a space within which the elastic element is disposed.

14. The method of claim 11 comprising:
shaping the elastic element as a disc with a center opening and a periphery opposite the center opening at an outermost edge of the elastic element; and
casting a cross sectional profile of the elastic element with a first thickness at the center opening and a second thickness at the periphery, wherein the first and second thicknesses are different from one another.

15. The method of claim 11 comprising casting the elastic element with a cross sectional profile with a thickness that varies.

16. The method of claim 15 comprising:
casting ribs on the elastic element; and
casting grooves between the ribs, wherein the ribs and grooves are configured to vary the force as the elastic element deflects.

17. The method of claim 11 comprising:
positioning the elastic element in a continuously variable transmission;
assembling a sheave in the continuously variable transmission that has a variable in diameter; and
applying, by the elastic element, the force to the sheave.

18. The method of claim 17 comprising:
engaging the sheave with a piston rod; and
positioning the elastic element around the rod.

19. The system of claim 18 comprising:
shaping the elastic element as a disc with an opening at its center; and
extending the rod through the opening.

20. A system comprising:
an elastic element formed in a disc shape and configured to deflect from a base shape when a load is applied to the elastic element and to resume the base shape when the load is removed, the elastic element cast of a metallic glass material;
a rib cast onto the elastic element configured to vary a force applied by the elastic element as the elastic element deflects; and
a moveable element upon which the elastic element applies the force.
